(19) United States
(12) Patent Application Publication
(10) Pub. No.: US 2024/0095971 A1
(43) Pub. Date: Mar. 21, 2024

(54) IMAGE PROCESSING SYSTEM, IMAGE PROCESSING METHOD, AND NON-TRANSITORY COMPUTER-READABLE MEDIUM

(71) Applicant: NEC Corporation, Minato-ku, Tokyo (JP)

(72) Inventors: Eisuke Kawakami, Tokyo (JP); Yasunari Tsuji, Tokyo (JP)

(73) Assignee: NEC Corporation, Minato-ku, Tokyo (JP)

(21) Appl. No.: 18/272,957

(22) PCT Filed: Dec. 23, 2021
(86) PCT No.: PCT/JP2021/047880

§ 371 Date: Jul. 18, 2023

(30) Foreign Application Priority Data
Jan. 21, 2021 (JP) 2021-007923

(51) Int. Cl. G06T 11/00; G06T 7/70

(52) U.S. Cl. CPC G06T 11/00; G06T 7/70; G06T 2207/10016; G06T 2207/30176

(57) ABSTRACT

An image processing system (1) includes an image analysis unit (110), an image acquisition unit (120), and a guide information output unit (130). The image analysis unit (110) analyzes an image in a video captured by an image capturing apparatus, and detects a pose of a personal identification document in the image. The image acquisition unit (120) acquires, as an image to be processed, an image in the video in which a pose associated to any of a plurality of reference poses preset for the personal identification document is detected. The guide information output unit (130) outputs, onto the video, guide information representing a reference pose of the personal identification document while changing a type and a display position thereof, depending on a detection result of a pose of the personal identification document.

### TECHNICAL FIELD

The present invention relates to a technique of personal identification using an image of a personal identification document.

### BACKGROUND ART

For example, at a time of opening a bank account or issuing a credit card, personal identification is performed by using a personal identification document such as a driver's license. In recent years, what is called electronic know your customer (eKYC) service has also been provided, in which an image of a personal identification document is captured by using a camera, and personal identification is performed online.

In a case of performing personal identification by using an image of a personal identification document, there is a possibility that a malicious person uses a fake personal identification document. Thus, a mechanism for confirming use of an authentic personal identification document is necessary. For example, Patent Document 1 mentioned below discloses a technique for strictly performing online personal identification.

Patent Document 1 discloses the technique for outputting a guide screen for specifying an arrangement position of a driver's license, and specifying an arrangement position of a coin whose image is captured together with the driver's license, and acquiring a personal identification image in which the driver's license and the coin are arranged according to the guide screen. In the technique disclosed in Patent Document 1, the arrangement position of the coin in the guide screen is determined at random.

### RELATED DOCUMENT

### Patent Document

Patent Document 1: Japanese Patent Application Publication No. 2020-161191

### SUMMARY OF THE INVENTION

### Technical Problem

In the technique disclosed in Patent Document 1, images of a personal identification document are captured in various poses (a front surface, a side surface, a back surface, and the like), and the images are used in determining authenticity of the personal identification document. However, in case of capturing an image of the personal identification document in a certain pose, and then capturing an image of the personal identification document in a different pose, a user needs to operate a terminal each time.

The present invention has been made in view of the above-described problem. One of objects of the present invention is to provide a technique for improving convenience of a system in which personal identification is performed by using an image of a personal identification document.

### Solution to Problem

A first image processing system in the present disclosure includes:
an image analysis unit that analyzes an image in a video captured by an image capturing apparatus, and detects a pose of a personal identification document in the image;
an image acquisition unit that acquires, as an image to be processed, an image in the video in which a pose associated to any of a plurality of reference poses preset for the personal identification document is detected; and
a guide information output unit that outputs, onto the video, guide information representing a reference pose of the personal identification document while changing a type and a display position thereof, depending on a detection result of a pose of the personal identification document.

A second image processing system in the present disclosure includes:
an image analysis unit that analyzes an image in a video captured by an image capturing apparatus, and detects a pose of a personal identification document in the image;
an image acquisition unit that acquires, as an image to be processed, an image in the video in which a pose associated to any of a plurality of reference poses preset for the personal identification document is detected; and
a guide information output unit that outputs, onto the video, guide information representing a reference pose of the personal identification document while changing a type thereof, depending on a detection result of a pose of the personal identification document.

A first image processing method in the present disclosure is executed by a computer.

The first image processing method includes:
analyzing an image in a video captured by an image capturing apparatus, and detecting a pose of a personal identification document in the image;
acquiring, as an image to be processed, an image in the video in which a pose associated to any of a plurality of reference poses preset for the personal identification document is detected; and
outputting, onto the video, guide information representing a reference pose of the personal identification document while changing a type and a display position thereof, depending on a detection result of a pose of the personal identification document.

A second image processing method in the present disclosure is executed by a computer.

The second image processing method includes:
analyzing an image in a video captured by an image capturing apparatus, and detecting a pose of a personal identification document in the image;
acquiring, as an image to be processed, an image in the video in which a pose associated to any of a plurality of reference poses preset for the personal identification document is detected; and
outputting, onto the video, guide information representing a reference pose of the personal identification document while changing a type thereof, depending on a detection result of a pose of the personal identification document.

A first program in the present disclosure causes a computer to function as:
an image analysis unit that analyzes an image in a video captured by an image capturing apparatus, and detects a pose of a personal identification document in the image;
an image acquisition unit that acquires, as an image to be processed, an image in the video in which a pose associated to any of a plurality of reference poses preset for the personal identification document is detected; and
a guide information output unit that outputs, onto the video, guide information representing a reference pose of the personal identification document while changing a type and a display position thereof, depending on a detection result of a pose of the personal identification document.

A second program in the present disclosure causes a computer to function as:
an image analysis unit that analyzes an image in a video captured by an image capturing apparatus, and detects a pose of a personal identification document in the image;
an image acquisition unit that acquires, as an image to be processed, an image in the video in which a pose associated to any of a plurality of reference poses preset for the personal identification document is detected; and
a guide information output unit that outputs, onto the video, guide information representing a reference pose of the personal identification document while changing a type thereof, depending on a detection result of a pose of the personal identification document.

### Advantageous Effects of Invention

According to the present invention, it is possible to improve convenience of a system in which personal identification is performed by using an image of a personal identification document.

### BRIEF DESCRIPTION OF THE DRAWINGS

FIG. 1 is a diagram illustrating a system configuration of an image processing system in a first example embodiment.

FIG. 2 is a block diagram illustrating a hardware configuration of the image processing system.

FIG. 3 is a flowchart illustrating a flow of processing executed by the image processing system of the first example embodiment.

FIG. 4 is a diagram illustrating one example of a screen that includes guide information displayed by a guide information output unit of the first example embodiment.

FIG. 5 is a diagram illustrating one example of a screen that includes guide information displayed by the guide information output unit of the first example embodiment.

FIG. 6 is a diagram illustrating one example of a screen that includes guide information displayed by the guide information output unit of the first example embodiment.

FIG. 7 is a diagram illustrating a relation between display positions of guide information before and after changing.

FIG. 8 is a flowchart illustrating a flow of processing executed by an image processing system of a second example embodiment.

FIG. 9 is a diagram illustrating one example of a screen including guide information displayed by a guide information output unit of the second example embodiment.

FIG. 10 is a diagram illustrating one example of a screen including guide information displayed by the guide information output unit of the second example embodiment.

FIG. 11 is a diagram illustrating one example of a screen including guide information displayed by the guide information output unit of the second example embodiment.

### DESCRIPTION OF EMBODIMENTS

Hereinafter, example embodiments of the present invention will be described with reference to the drawings. Note that, in all the drawings, a similar constituent element is denoted by a similar reference sign, and the description thereof will be appropriately omitted. Further, in each block diagram, each block does not represent a configuration in a hardware unit, but represents a configuration of a function unit, unless there is a particular description. Furthermore, an orientation of an arrow in the drawings is merely for the purpose of making a flow or the like of information easier to understand, and do not limit a direction of communication (one-way communication/two-way communication), unless there is a particular description.

### First Example Embodiment

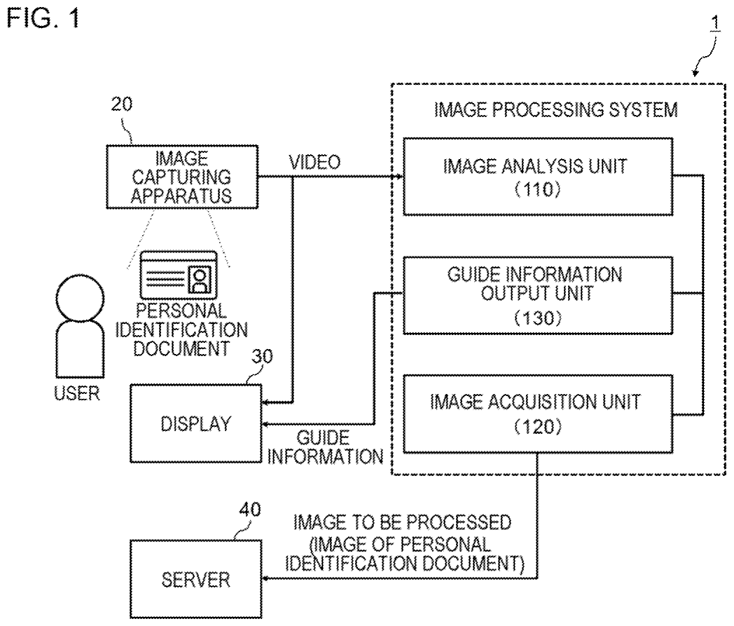

FIG. 1 is a diagram illustrating a system configuration of an image processing system according to a first example embodiment.

An image capturing apparatus 20 captures a video of a personal identification document at any frame rate, and supplies the video to an image processing system 1. Further, the video captured by the image capturing apparatus 20 is also displayed on a display 30. A user who provides a personal identification document to the image capturing apparatus 20 moves the personal identification document while watching the video displayed on the display 30 and confirming a current pose of the personal identification document. Such an operation performed by a user enables the image processing system 1 to acquire an image of the personal identification document necessary for later personal identification. The image processing system 1 transmits the image of the personal identification document acquired by below-described processing, to a server 40 that executes personal identification processing.

### <Functional Configuration Example of Image Processing System 1>

The image processing system 1 illustrated in FIG. 1 includes an image analysis unit 110, an image acquisition unit 120, and a guide information output unit 130.

The image analysis unit 110 acquires a video of a personal identification document captured by the image capturing apparatus 20.

Then, the image analysis unit 110 analyzes an image constituting the acquired video, and detects the personal identification document from the image. At this time, the image analysis unit 110 also detects a pose of the personal identification document. Herein, a “pose” of the personal identification document unit a view orientation (e.g., an orientation such as a front surface/a side surface/a back surface of the personal identification document, an inclined angle of the personal identification document, or the like) of the personal identification document in the image.

The image analysis unit 110 can detect an image area associated to the personal identification document, for example, based on an edge feature value extracted from an image. The image analysis unit 110 can estimate a pose of the personal identification document, based on a feature value acquired from the detected image area. For example, the image analysis unit 110 can acquire text information from an image area by using an optical character recognition (OCR) technique or the like, and estimate an orientation (front surface/side surface/back surface) of the personal identification document, based on a specific keyword detected from the text information. Further, the image analysis unit 110 can estimate an inclined angle of the personal identification document, based on inclination information of text information acquired by analyzing an image. Alternatively, the image analysis unit 110 may be configured in such a way as to detect a pose of the personal identification document, based on an analysis result (e.g., a detected state of a face photograph, an inclined angle of the face photograph, or the like) of the image area of the personal identification document. Further, alternatively, for example, the image analysis unit 110 may be configured in such a way as to determine whether the personal identification document exists in an image, by using a learned model constructed by machine learning in such a way as to be able to detect a personal identification document of any type and a pose of the personal identification document. Further, alternatively, the image analysis unit 110 may be configured in such a way as to detect the personal identification document and a pose of the personal identification document, from a target image, by processing of matching with preregistered images of a personal identification document in various poses.

The image acquisition unit 120 acquires, based on a pose of a personal identification document detected by the image analysis unit 110, an image (hereinafter, referred to also as an “image to be processed”) to be used for personal identification processing. For example, the image acquisition unit 120 collate the pose of the personal identification document detected by the image analysis unit 110 with a plurality of reference poses preset for the personal identification document. Herein, when the pose of the personal identification document detected by the image analysis unit 110 is associated to any of a plurality of the reference poses, the image acquisition unit 120 acquires, as an image to be processed, an image in which the pose is detected. For example, the image acquisition unit 120 reads out data of a plurality of the reference poses from a storage unit (not illustrated) storing the data, and performs processing of deciding a similarity degree between the pose of the personal identification document detected by the image analysis unit 110 and each of a plurality of the reference poses. When, as a result, the similarity degree equal to or more than a predetermined threshold value is acquired for any of a plurality of the reference poses, the image acquisition unit 120 acquires, as an image to be processed, an image in which the pose indicating such a similarity degree is detected.

The guide information output unit 130 outputs guide information representing a reference pose of the personal identification document, onto a video displayed on the display 30, in order to cause a user to recognize the reference pose of the personal identification document. According to the present example embodiment, depending on a result of detection of the pose of the personal identification document by the image analysis unit 110, the guide information output unit 130 changes a type and a display position of the guide information to be output onto the video.

For example, it is assumed that three poses are preset as the reference poses of the personal identification document. In this case, the guide information output unit 130 first outputs guide information (first guide information) associated to any of the three reference poses, onto the video displayed on the display 30. At this time, the guide information output unit 130 outputs the first guide information to a position (first position) determined randomly or in accordance with a predetermined rule. It is assumed that a user then moves the personal identification document while confirming the display related to the first guide information, and as a result, the analysis unit 110 detects, at a position associated to the first position, a pose associated to the reference pose specified by the first guide information. Depending on this detected result, the guide information output unit 130 outputs, onto the video displayed on the display 30, one (second guide information) of the remaining two pieces of guide information in such a way as to replace the first guide information. At this time, the guide information output unit 130 outputs the second guide information to a position (second position) different from the first position to which the first guide information was output. It is assumed that the user then moves the personal identification document further while confirming the display related to the second guide information, and as a result, the analysis unit 110 detects, at a position associated to the second position, a pose associated to the reference pose specified by the second guide information. Depending on this detected result, the guide information output unit 130 outputs, onto the video displayed on the display 30, the last guide information (third guide information) yet to be displayed, in such a way as to replace the second guide information. At this time, the guide information output unit 130 outputs the third guide information to a position (third position) different from at least the second position to which the second guide information was output. It is assumed that the user then moves the personal identification document further while confirming the display related to the third guide information, and as a result, the analysis unit 110 detects, at a position associated to the third position, a pose associated to the reference pose specified by the third guide information. Depending on this detected result, the guide information output unit 130 can recognize that all of the three preset reference poses have been detected (i.e., that all of the necessary images to be processed have been acquired by the image acquisition unit 120). In this case, the guide information output unit 130 can display, on a display of a user terminal 10, for example, a message indicating that acquisition of the images necessary for personal identification has been completed.

Note that, an operation of the guide information output unit 130 is not limited to a content of the above-described specific example. For example, the guide information output unit 130 may be configured in such a way as to switch a type and a display position of the guide information in response to receiving, from the image acquisition unit 120, notification indicating that the image to be processed has been acquired.

When all of the images to be processed necessary for personal identification are acquired, the image processing system 1 transmits these images to be processed to the server 40 that performs the personal identification processing. The server 40 executes the personal identification processing using the image to be processed received from the image processing system 1. When a user is authenticated as a person himself or herself by the processing of the server 40, the user can enjoy service such as opening of an account and issuing of a credit card.

### <Hardware Configuration Example>

Each functional configuration unit of the image processing system 1 may be achieved by hardware (example: hardwired electronic circuit or the like) that achieves each functional configuration unit, or may be achieved by a combination of hardware and software (example: a combination of an electronic circuit and a program that controls the electronic circuit). The following further describes a case where each functional configuration unit of the image processing system 1 is achieved by a combination of hardware and software.

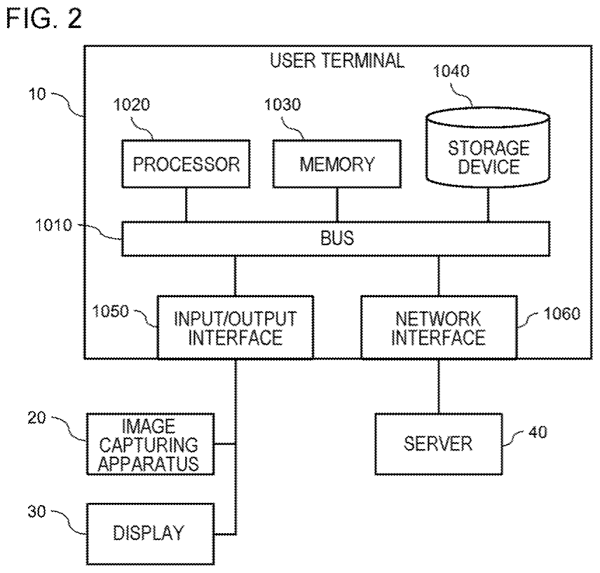

FIG. 2 is a block diagram illustrating a hardware configuration of the image processing system 1. In the present figure, the image processing system 1 is implemented on the user terminal 10. For example, installing a dedicated application in the user terminal 10 enables an environment of the image processing system 1 to be constructed.

The user terminal 10 includes a bus 1010, a processor 1020, a memory 1030, a storage device 1040, an input/output interface 1050, and a network interface 1060.

The bus 1010 is a data transmission path for transmitting and receiving data between each hardware constituent element. However, a method of connecting each hardware constituent element of the user terminal 10 with one another is not limited to bus connection.

The processor 1020 is a processor achieved by a central processing unit (CPU), a graphics processing unit (GPU), or the like.

The memory 1030 is a main storage apparatus achieved by a random access memory (RAM), or the like.

The storage device 1040 is an auxiliary storage apparatus achieved by a hard disk drive (HDD), a solid state drive (SSD), a memory card, a read only memory (ROM), or the like. The storage device 1040 stores a program module that achieves each function (the image analysis unit 110, the image acquisition unit 120, the guide information output unit 130, and the like) of the image processing system 1. The processor 1020 reads each of these program modules onto the memory 1030 and executes the read program modules, and thereby, each function associated to each program module is achieved on the user terminal 10.

The input/output interface 1050 is an interface for connecting the user terminal 10 to various pieces of input/output equipment. In the example in FIG. 2, the image capturing apparatus 20 and the display 30 in FIG. 1 are connected to the input/output interface 1050. In other words, in the example in the present figure, the image capturing apparatus 20 and the display 30 are mounted on the user terminal 10. Note that, the display 30 connected to the input/output interface 1050 may be a touch panel display mounting a touch panel. Other input/output apparatuses such as a keyboard, a mouse, and a speaker can be connected to the input/output interface 1050.

The network interface 1060 is an interface for connecting the user terminal 10 to a network. The network interface 1060 connects the user terminal 10 to the network by wired or wireless. The network is a local area network (LAN) or a wide area network (WAN), for example. The user terminal 10 can communicate with another apparatus on the network via the network interface 1060, and transmit and receive various pieces of data. For example, the user terminal 10 can communicate with the server 40 via the network interface 1060, and transmit an image to be processed to the server 40. In addition, when the image capturing apparatus 20 exists as another apparatus separate from the user terminal 10 and is connected to the network, the user terminal 10 can communicate with the image capturing apparatus 20 via the network interface 1060, and acquire a video of a personal identification document from the image capturing apparatus 20.

Note that, the configuration in FIG. 2 is merely one example, and the present invention is not limited to a content illustrated in FIG. 2. For example, a part or all of each function of the image processing system 1 may be provided in an apparatus other than the user terminal 10. For example, the server 40 may include the image analysis unit 110, the image acquisition unit 120, and the guide information output unit 130. In this case, the user terminal 10 transmits, to a server apparatus, a video captured by using the image capturing apparatus 20, and the server apparatus executes each pieces of processing described above by using the video acquired from the user terminal 10.

### <Flow of Processing>

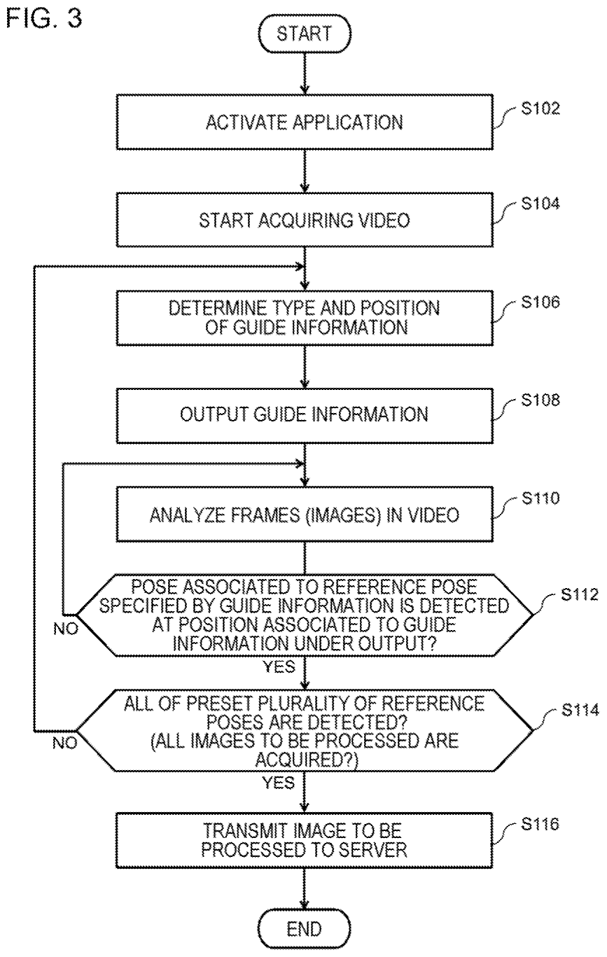

FIG. 3 is a flowchart illustrating a flow of processing executed by the image processing system 1 of the first example embodiment. The present figure illustrates a flowchart when the image processing system 1 is implemented on the user terminal 10.

First, a user operates the user terminal 10, and activates an application of the image processing system 1 installed in the user terminal 10 (S102). In response to activation of the application, the user terminal 10 communicates with the image capturing apparatus 20 connected to the user terminal 10, and starts acquiring a video (S104).

In response to the activation of the application, the guide information output unit 130 determines a type and a display position of guide information to be output on the video acquired from the image capturing apparatus 20 (S106). For example, the guide information output unit 130 refers to data of guide information stored in advance in a storage area such as the storage device 1040, and determines a type of guide information to be first output. When a type of guide information to be first output is predetermined, the guide information output unit 130 reads out data of the guide information predetermined to be first output. For example, when a personal identification document is rotated, and various poses of the personal identification document are captured by the image capturing apparatus 20, the guide information related to a front surface can be set as the guide information to be first output. Further, randomly or based on a predetermined rule, the guide information output unit 130 determines a display position of the read-out guide information on the display 30, for example, within a range where the video of the image capturing apparatus 20 is displayed.

Herein, depending on performance or the like of the image capturing apparatus 20 and the display 30, there is a possibility that distortion or blurring occurs, in the video, in an area near a boundary portion of an angle view of the image capturing apparatus 20. When the guide information is displayed in such an area, there is a possibility that detection accuracy of the personal identification document and a pose of the personal identification document is reduced. Thus, the guide information output unit 130 controls a display position of the guide information in such a way as to avoid such an area. Specifically, the guide information output unit 130 controls a display position of the guide information within a range narrower than the angle view of the image capturing apparatus 20. Information related to the angle view of the image capturing apparatus 20 is, for example, added as metadata to a video of the image capturing apparatus 20. Further, alternatively, the guide information output unit 130 may acquire model information stored on the user terminal 10, and acquire, based on the model information, specification information (e.g., information of the angle view) of the image capturing apparatus 20 being mounted on the user terminal 10.

The guide information output unit 130 outputs the guide information of the type determined in the processing of S106, to the display position determined also in the processing of S106 (S108). According to the guide information displayed on the display 30, a user moves the personal identification document in such a way that the personal identification document is shifted to a specified position, and changes an orientation of the personal identification document in such a way as to make a specified pose.

A video captured by the image capturing apparatus 20 is supplied to the image processing system 1 even while a user is moving the personal identification document as described above. The image analysis unit 110 sequentially analyzes video frames (images) supplied to the image processing system 1 (S110). Note that, the image analysis unit 110 may select, as a frame to be analyzed, all of the frames (images) of the supplied video, or may select a frame (image) to be analyzed at a constant time interval. Then, based on an analysis result of the images, the image analysis unit 110 decides whether a pose associated to a reference pose specified by the guide information output onto the display 30 has been detected at a position associated to the display position of the guide information (S112).

When a pose associated to the reference pose specified by the guide information has not been detected at a position associated to the display position of the guide information (S112: NO), the image analysis unit 110 continues analysis of video frames (images) supplied to the image processing system 1. On the other hand, when a pose associated to the reference pose specified by the guide information has been detected at a position associated to the display position of the guide information (S112: YES), the guide information output unit 130 further decides whether all of a plurality of preset reference poses have been detected (S114).

When all of a plurality of the preset reference poses have not been detected (S114: NO), it is a state where all of images necessary for personal identification have not been acquired, and thus, the processing turns to S106. Then, the guide information output unit 130 changes a type of guide information and a display position of the guide information. For example, the guide information output unit 130 causes guide information of another type newly determined in the processing of S106 to be displayed away by a fixed distance (e.g., a fixed value of 20 to 30 pixels) from a current display position of the guide information. Then, the processing of S110 to S114 is repeatedly executed. On the other hand, when all of a plurality of the preset reference poses have been detected (S114: YES), it is a state where all of images necessary for personal identification have been acquired, and thus, the processing turns to S116. In the processing of S116, the image processing system 1 transmits all of the acquired images to be processed to the server 40 that executes personal identification processing (S116).

As described above, according to the image processing system 1 of the present example embodiment, guide information representing a reference pose of a personal identification document is output onto a video that a user confirms in order to acquire an image necessary for personal identification. A user who provides a personal identification document moves the personal identification document according to the guide information, and thereby, the image necessary for personal identification can be easily captured. Further, in the image processing system 1 of the present example embodiment, a type of guide information to be output onto a video that a user confirms is automatically switched depending on detection of a pose associated to the reference pose of the personal identification document. Thereby, images necessary for personal identification can be successively captured without further performing operation on the user terminal 10 by a user for continuing to capture an image of the personal identification document. In other words, convenience of the system is improved. Further, in the image processing system 1 of the present example embodiment, at a time of switching guide information, the guide information after switching is output to a position different from a position to which the guide information before switching was output. Such a manner makes it impossible to acquire an image necessary for personal identification unless a display position of the guide information is confirmed in real time and the display is obeyed. This makes it possible to prevent an image of the personal identification document from being acquired by using a malicious program, for example. For example, even when a malicious program that uses a previously captured video or the like is used to the present system, an image for personal identification is not acquired and the personal identification processing is not executed unless the personal identification document captured in the video is accurately moved according to the display position of the guide information. In this regard, according to the image processing system 1 of the present example embodiment, security of the personal identification processing can be enhanced.

### <Display Position of Guide Information>

In case of changing a display position of guide information, when a difference (movement amount) between display positions of the guide information before and after changing is too small, an effect related to the above-described security is reduced. Thus, the guide information output unit 130 is preferably configured in such a way as to determine a display position of the guide information after the changing in such a way that a difference (movement amount) between display positions of the guide information before and after the changing becomes a movement amount equal to or more than a predetermined first threshold value.

On the other hand, in case of changing a display position of guide information, when a difference (movement amount) between display positions of the guide information before and after changing is too large, a user needs to move a personal identification document by a large amount, and an effect related to the above-described convenience is reduced. Thus, it is preferable to set an upper limit for a movement amount of a display position of the guide information. For example, the guide information output unit 130 may be configured in such a way as to determine a display position of the guide information after the changing in such a way that a movement amount between the guide information before and after the changing falls within a range from the above-described first threshold value to a second threshold value larger than the first threshold value.

### <Screen Display Examples of Guide Information>

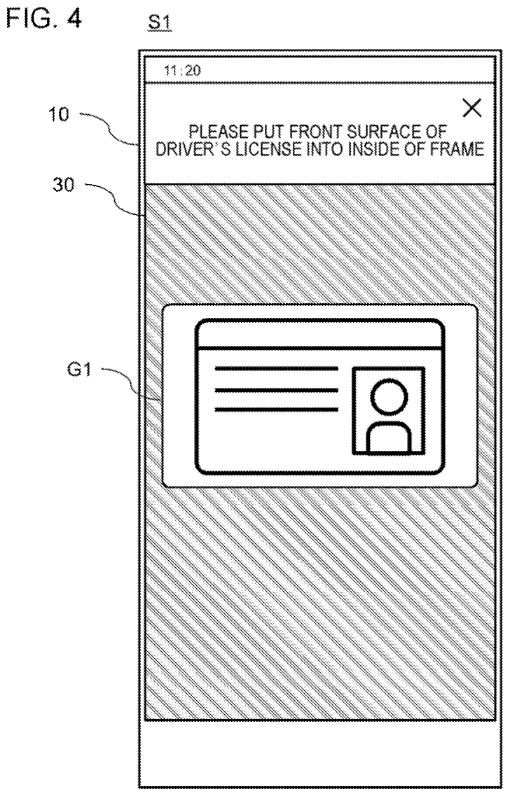

FIGS. 4 to 6 are diagrams illustrating one example of a screen that includes guide information displayed by the guide information output unit 130 of the first example embodiment. FIGS. 4 to 6 illustrate screens sequentially displayed on the display 30 along a time lapse.

Specifically, the guide information output unit 130 first displays, on the display 30, a screen S1 illustrated in FIG. 4. The screen S1 illustrated in FIG. 4 includes guide information G1 in a vicinity of a center of a display area of the display 30. The guide information G1 is guide information for acquiring an image of a front surface of a personal identification document (herein, a driver's license). In the example in FIG. 4, the guide information output unit 130 adjusts an area (hatched area) except the guide information G1 in such a way as to be displayed darker than an area of the guide information G1. Thereby, the guide information G1 can be made noticeable. A user provides the personal identification document (driver's license) at a position associated to a display position of the guide information G1, in a pose associated to a reference pose specified by the guide information G1, and thereby, a first image to be processed in which the front surface of the personal identification document (driver's license) is captured is acquired.

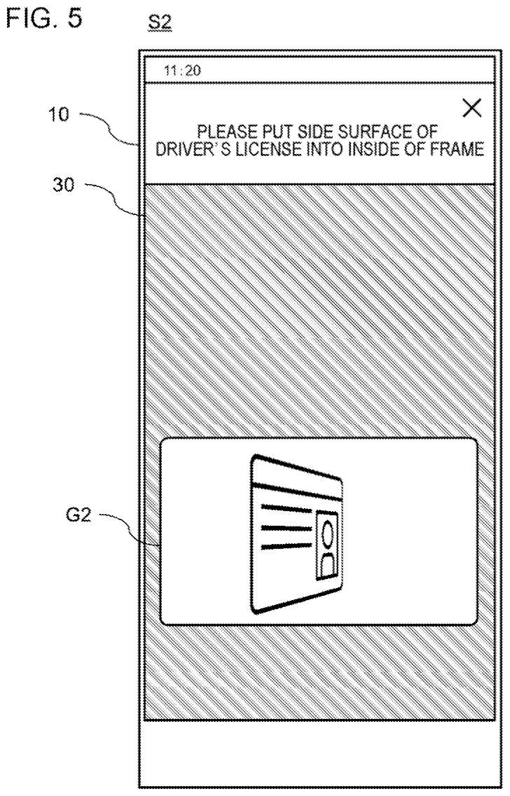

When the first image to be processed is acquired in the screen S1 (a pose associated to the reference pose specified by the guide information G1 is detected), the guide information output unit 130 displays, on the display 30, a screen S2 illustrated in FIG. 5. The screen S2 illustrated in FIG. 5 includes guide information G2 in a vicinity of a lower portion of the display area of the display 30. The guide information G2 is guide information for acquiring an image of a side surface of the personal identification document (herein, the driver's license). In the example in FIG. 5, the guide information output unit 130 changes a display position of the guide information along a height direction (downward direction) of the display 30 (the display area for displaying a video). Further, in the example in FIG. 5, similarly to FIG. 4, the guide information output unit 130 adjusts an area (hatched area) except the guide information G2 in such a way as to be displayed darker than an area of the guide information G2. Thereby, the guide information G2 can be made noticeable. The user provides the personal identification document (driver's license) at a position associated to a display position of the guide information G2, in a pose associated to a reference pose specified by the guide information G2, and thereby, a second image to be processed in which the side surface of the personal identification document (driver's license) is captured is acquired.

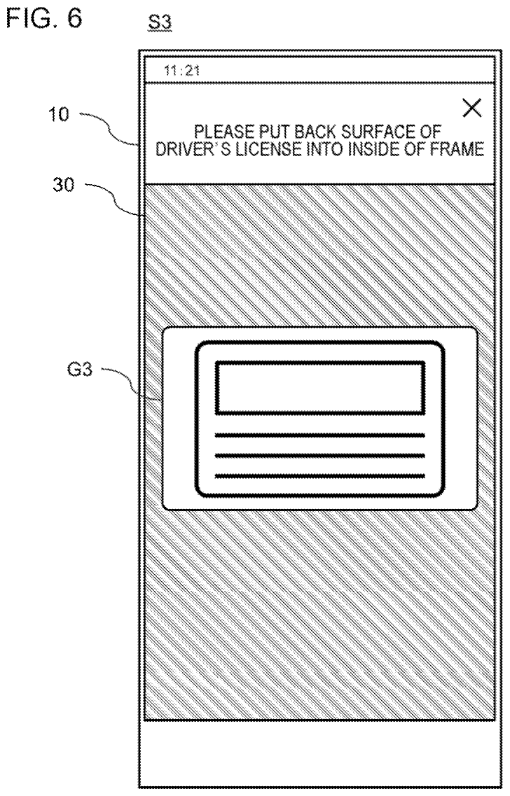

When the second image to be processed is acquired in the screen S2 (a pose associated to the reference pose specified by the guide information G2 is detected), the guide information output unit 130 displays, on the display 30, a screen S3 illustrated in FIG. 6. The screen S3 illustrated in FIG. 6 includes guide information G3 in a vicinity of the center of the display area of the display 30. The guide information G3 is guide information for acquiring an image of a back surface of the personal identification document (herein, the driver's license). In the example in FIG. 6, the guide information output unit 130 changes a display position of the guide information along a height direction (upward direction) of the display 30 (the display area for displaying a video). Further, in the example in FIG. 6, similarly to FIGS. 4 and 5, the guide information output unit 130 adjusts an area (hatched area) except the guide information G3 in such a way as to be displayed darker than an area of the guide information G3. Thereby, the guide information G3 can be made noticeable. The user provides the personal identification document (driver's license) at a position associated to a display position of the guide information G3, in a pose associated to a reference pose specified by the guide information G3, and thereby, a third image to be processed in which the back surface of the personal identification document (driver's license) is captured is acquired.

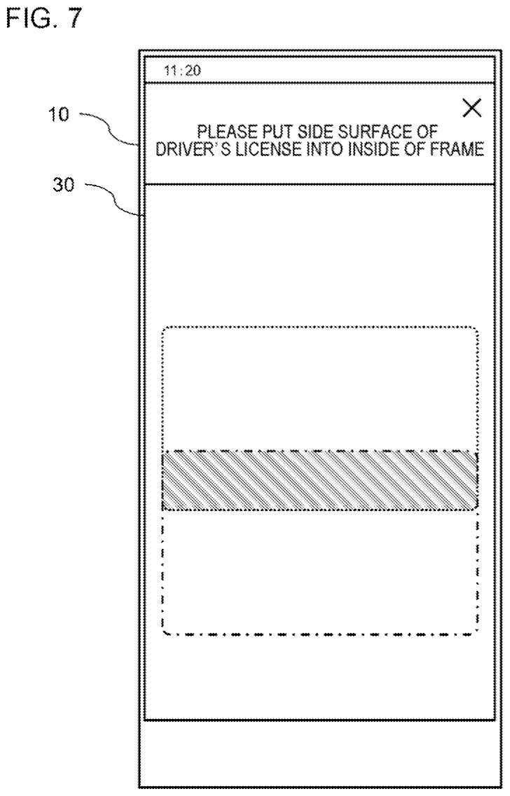

Note that, as described above, there is a possibility that when a movement amount of guide information is too small, security is reduced, and when a movement amount of the guide information is too large, convenience of the system is reduced. Thus, the guide information output unit 130 may display the guide information after the changing, at a position that at least partially overlaps with a display position of the guide information before the changing. Specifically, as illustrated in FIG. 7 for example, the guide information output unit 130 may adjust a display position of the guide information after the changing in such a way that a display position of the guide information before the changing and a display position of the guide information after the changing overlaps with each other by approximately ¼ to ⅓ of a display size as a reference. FIG. 7 is a diagram illustrating a relation between display positions of the guide information before and after the changing. In the example in FIG. 7, the display position of the guide information before the changing is indicated by a dashed line. Further, in the example in FIG. 7, the display position of the guide information after the changing is indicated by a one-dotted chain line. Furthermore, in the example in FIG. 7, an overlap of the display positions of the guide information before and after the changing is indicated by hatching. The guide information output unit 130 controls a size of the hatched area in such a way as to be approximately ¼ to ⅓ of a size (height, width, area) of the displayed guide information as a reference.

### Modified Example

The guide information output unit 130 may be configured in such a way as to change guide information along a width direction of the display 30 (a display area for displaying a video). In this case, the guide information output unit 130 recognizes an orientation of the user terminal 10 (an orientation of the display 30), based on information acquired from an inertial measurement apparatus such as a gyro sensor mounted on the user terminal 10, for example. Then, the guide information output unit 130 controls a changing direction of a display position of the guide information, based on the orientation of the user terminal 10 (the orientation of the display 30). Further, the guide information output unit 130 may control a display position of the guide information in the height direction and the width direction regardless of an orientation of the user terminal 10 (an orientation of the display 30).

Although not illustrated, the image processing system 1 may further include a function of further outputting, onto the display 30, any information for informing a user that an image to be processed has been acquired. For example, the image processing system 1 may include a function of outputting a progress bar, a predetermined message, or the like when acquiring an image to be processed. Thereby, a user can visually recognize that an image necessary for personal identification has been acquired.

### Second Example Embodiment

An image processing system 1 of the present example embodiment is similar to the image processing system 1 of the first example embodiment, except for a point described below.

### <Functional Configuration of Image Processing System 1>

Similarly to the configuration example (FIG. 1) of the image processing system 1 of the first example embodiment, the image processing system 1 of the present example embodiment includes an image analysis unit 110, an image acquisition unit 120, and a guide information output unit 130. The image analysis unit 110 and the image acquisition unit 120 in the present example embodiment are similar to those in the first example embodiment. The guide information output unit 130 in the present example embodiment differs from the guide information output unit 130 in the first example embodiment, in not changing a display position of guide information. Specifically, the guide information output unit 130 in the present example embodiment changes a type of guide information to be output onto a video, depending on a result of detection of a pose of a personal identification document by the image analysis unit 110.

### <Hardware Configuration Example>

A hardware configuration of the image processing system 1 of the present example embodiment is similar to the hardware configuration example (FIG. 2) of the image processing system 1 of the first example embodiment. A storage device 1040 stores a program module that achieves each function (the image analysis unit 110, the image acquisition unit 120, the guide information output unit 130, and the like) of the image processing system 1 according to the present example embodiment. A processor 1020 reads each of these program modules onto a memory 1030 and executes the read program modules, and thereby, each function associated to each program module is achieved on a user terminal 10.

### <Flow of Processing>

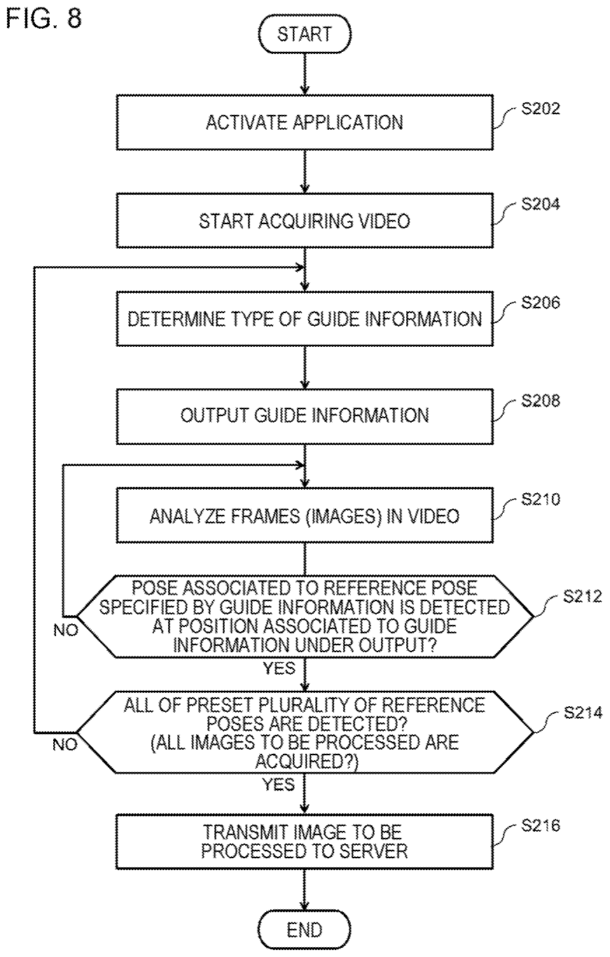

FIG. 8 is a flowchart illustrating a flow of processing executed by the image processing system 1 of the second example embodiment. The present figure illustrates a flowchart when the image processing system 1 is implemented on the user terminal 10.

First, a user operates the user terminal 10, and activates an application of the image processing system 1 installed in the user terminal 10 (S202). In response to activation of the application, the user terminal 10 communicates with an image capturing apparatus 20 connected to the user terminal 10, and starts acquiring a video (S204). Such processing is similar to the processing of S102 and S104 in FIG. 3.

In response to the activation of the application, the guide information output unit 130 determines a type of guide information to be output onto the video acquired from the image capturing apparatus 20 (S206). For example, the guide information output unit 130 refers to data of guide information stored in advance in a storage area such as the storage device 1040, and determines a type of guide information to be first output. When a type of guide information to be first output is predetermined, the guide information output unit 130 reads out data of the guide information predetermined to be first output. For example, when a personal identification document is rotated, and various poses of the personal identification document are captured by the image capturing apparatus 20, the guide information related to a front surface can be set as the guide information to be first output. In the present example embodiment, a display position of the guide information may be predetermined. For example, the guide information output unit 130 may output the guide information in such a way that a center of an area of the guide information overlaps with a center of a display 30 (display area).

The guide information output unit 130 outputs, to the display 30, the guide information of the type determined in the processing of S206 (S208). According to the guide information displayed on the display 30, a user moves the personal identification document in such a way that the personal identification document is shifted to a specified position, and changes an orientation of the personal identification document in such a way as to make a specified pose.

A video captured by the image capturing apparatus 20 is supplied to the image processing system 1 even while a user is moving the personal identification document as described above. The image analysis unit 110 sequentially analyzes video frames (images) supplied to the image processing system 1 (S210). Then, based on an analysis result of the images, the image analysis unit 110 decides whether a pose associated to a reference pose specified by the guide information output onto the display 30 has been detected at a position associated to the display position of the guide information (S212). Such processing is similar to the processing of S110 and S112 in FIG. 3.

When a pose associated to the reference pose specified by the guide information has not been detected at a position associated to the display position of the guide information (S212: NO), the image analysis unit 110 continues analysis of video frames (images) supplied to the image processing system 1. On the other hand, when a pose associated to the reference pose specified by the guide information has been detected at a position associated to the display position of the guide information (S212: YES), the guide information output unit 130 further decides whether all of a plurality of preset reference poses have been detected (S214: YES). Such processing is similar to the processing of S112 and S114 in FIG. 3.

When all of a plurality of the preset reference poses have not been detected (S214: NO), it is a state where all of images necessary for personal identification have not been acquired, and thus, the processing turns to S206. Then, the guide information output unit 130 changes a type of guide information. For example, the guide information output unit 130 causes guide information of another type newly determined in the processing of S206 to be displayed at a current display position of the guide information. Then, the processing of S210 to S214 is repeatedly executed. On the other hand, when all of a plurality of the preset reference poses have been detected (S214: YES), it is a state where all of images necessary for personal identification have been acquired, and thus, the processing turns to S216. In the processing of S216, the image processing system 1 transmits all of the acquired images to be processed to a server 40 that executes personal identification processing (S216). The processing of S216 is similar to the processing of S116 in FIG. 3.

As described above, according to the image processing system 1 of the present example embodiment, guide information representing a reference pose of a personal identification document is output onto a video that a user confirms in order to acquire an image necessary for personal identification. A user who provides a personal identification document moves the personal identification document according to the guide information, and thereby, the image necessary for personal identification can be easily captured. Further, in the image processing system 1 of the present example embodiment, a type of guide information to be output onto a video that a user confirms is automatically switched depending on detection of a pose associated to the reference pose of the personal identification document. Thereby, images necessary for personal identification can be successively captured without further performing operation on the user terminal 10 by a user for continuing to capture an image of the personal identification document. In other words, convenience of the system is improved. Further, in the image processing system 1 of the present example embodiment, at a time of switching guide information, a display position of the guide information is not changed before and after switching, differently from the image processing system 1 of the first example embodiment. In this case, a user does not need to move personal identification processing, and thus, convenience of the system is improved for the user.

### <Screen Display Example of Guide Information>

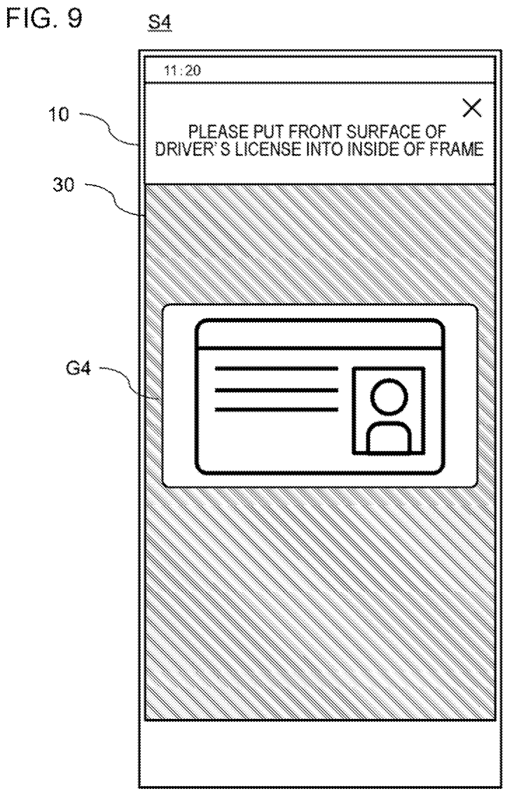

FIGS. 9 to 11 are diagrams illustrating one example of a screen that includes guide information displayed by the guide information output unit 130 of the second example embodiment. FIGS. 9 to 11 illustrate screens sequentially displayed on the display 30 along a time lapse.

Specifically, the guide information output unit 130 first displays, on the display 30, a screen S4 illustrated in FIG. 9. The screen S4 illustrated in FIG. 9 includes guide information G4 in a vicinity of a center of a display area of the display 30. The guide information G4 is guide information for acquiring an image of a front surface of a personal identification document (herein, a driver's license). In the example in FIG. 9, the guide information output unit 130 adjusts an area (hatched area) except the guide information G4 in such a way as to be displayed darker than an area of the guide information G4. Thereby, the guide information G4 can be made noticeable. A user provides the personal identification document (driver's license) at a position associated to a display position of the guide information G4, in a pose associated to a reference pose specified by the guide information G4, and thereby, a first image to be processed in which the front surface of the personal identification document (driver's license) is captured is acquired.

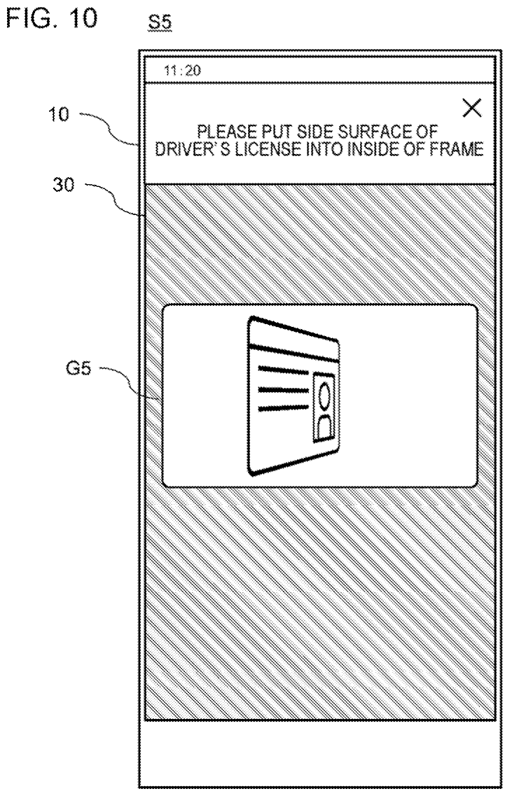

When the first image to be processed is acquired in the screen S4 (a pose associated to the reference pose specified by the guide information G4 is detected), the guide information output unit 130 displays, on the display 30, a screen S5 illustrated in FIG. 10. The screen S5 illustrated in FIG. 10 includes guide information G5 at the same position as that of the guide information G4 in the screen S4 in FIG. 9. The guide information G5 is guide information for acquiring an image of a side surface of the personal identification document (herein, the driver's license). In the example in FIG. 10, similarly to FIG. 9, the guide information output unit 130 adjusts an area (hatched area) except the guide information G5 in such a way as to be displayed darker than an area of the guide information G2. Thereby, the guide information G2 can be made noticeable. The user provides the personal identification document (driver's license) at a position associated to a display position of the guide information G5, in a pose associated to a reference pose specified by the guide information G5, and thereby, a second image to be processed in which the side surface of the personal identification document (driver's license) is captured is acquired.

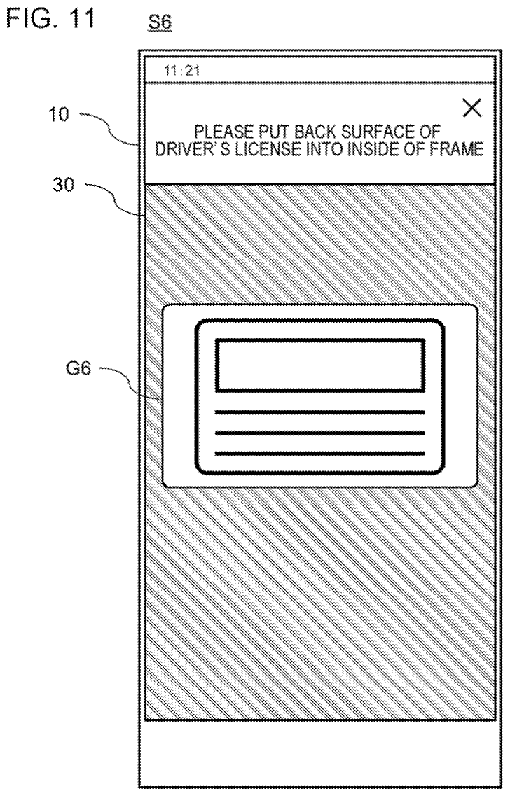

When the second image to be processed is acquired in the screen S5 (a pose associated to the reference pose specified by the guide information G5 is detected), the guide information output unit 130 displays, on the display 30, a screen S6 illustrated in FIG. 11. The screen S6 illustrated in FIG. 11 includes guide information G6 at the same position as those of the guide information G4 in the screen S4 in FIG. 9 and the guide information G5 in the screen S5 in FIG. 10. The guide information G6 is guide information for acquiring an image of a back surface of the personal identification document (herein, the driver's license). In the example in FIG. 11, similarly to FIGS. 9 and 10, the guide information output unit 130 adjusts an area (hatched area) except the guide information G6 in such a way as to be displayed darker than an area of the guide information G3. Thereby, the guide information G6 can be made noticeable. The user provides the personal identification document (driver's license) at a position associated to the display position of the guide information G6, in a pose associated to a reference pose specified by the guide information G6, and thereby, a third image to be processed in which the back surface of the personal identification document (driver's license) is captured is acquired.

Although the example embodiments of the present invention are described above with reference to the drawings, the present invention should not be interpreted as one limited to these, and various modifications, improvements, and the like can be made based on knowledge of those skilled in the art without departing from the essence of the present invention. Further, a plurality of the constituent elements disclosed in the example embodiments can be appropriately combined to form various inventions. For example, some constituent elements may be omitted from all the constituent elements mentioned in the example embodiments, or the constituent elements of the different example embodiments may be appropriately combined.

Further, in a plurality of the flowcharts used in the above description, a plurality of the steps (pieces of processing) are described in order, but the execution order of the steps executed in each example embodiment is not limited to the described order. In each example embodiment, the order of the illustrated steps can be changed within a range in which inconvenience does not occur in the contents. Furthermore, the above-described each example embodiment can be combined within a range in which contradiction does not occur in the contents.

A part or all of the above-described example embodiments can be also described as in the following supplementary notes, but there is no limitation to the following.
1.
An image processing system including:
an image analysis unit that analyzes an image in a video captured by an image capturing apparatus, and detects a pose of a personal identification document in the image;
an image acquisition unit that acquires, as an image to be processed, an image in the video in which a pose associated to any of a plurality of reference poses preset for the personal identification document is detected; and
a guide information output unit that outputs, onto the video, guide information representing a reference pose of the personal identification document while changing a type and a display position thereof, depending on a detection result of a pose of the personal identification document.
2.
The image processing system according to supplementary note 1, wherein
the guide information output unit changes a type and a display position of the guide information, in response to detection of a pose, as a pose of the personal identification document, associated to a reference pose specified by the guide information.
3.
The image processing system according to supplementary note 1 or 2, wherein
the guide information output unit causes a movement amount of a display position of the guide information between before and after changing of the display position to be equal to or more than a predetermined first threshold value.
4.
The image processing system according to supplementary note 3, wherein
the guide information output unit causes a movement amount of a display position of the guide information between before and after changing of the display position to be equal to or less than a second threshold value larger than the first threshold value.
5.
The image processing system according to any one of supplementary notes 1 to 4, wherein
the guide information output unit controls a display position of the guide information within a range narrower than an angle view of the image capturing apparatus.
6.
The image processing system according to any one of supplementary notes 1 to 5, wherein
the guide information output unit changes a display position of the guide information along a height direction of a display area for displaying the video.
7.
The image processing system according to any one of supplementary notes 1 to 6, wherein
the guide information output unit changes a display position of the guide information along a width direction of a display area for displaying the video.
8.
An image processing system including:
an image analysis unit that analyzes an image in a video captured by an image capturing apparatus, and detects a pose of a personal identification document in the image;
an image acquisition unit that acquires, as an image to be processed, an image in the video in which a pose associated to any of a plurality of reference poses preset for the personal identification document is detected; and
a guide information output unit that outputs, onto the video, guide information representing a reference pose of the personal identification document while changing a type thereof, depending on a detection result of a pose of the personal identification document.
9.
An image processing method executed by a computer, including:
analyzing an image in a video captured by an image capturing apparatus, and detecting a pose of a personal identification document in the image;
acquiring, as an image to be processed, an image in the video in which a pose associated to any of a plurality of reference poses preset for the personal identification document is detected; and
outputting, onto the video, guide information representing a reference pose of the personal identification document while changing a type and a display position thereof, depending on a detection result of a pose of the personal identification document.
10.
The image processing method according to supplementary note 9, further including,
by the computer,
changing a type and a display position of the guide information, in response to detection of a pose, as a pose of the personal identification document, associated to a reference pose specified by the guide information.
11.
The image processing method according to supplementary note 9 or 10, further including,
by the computer,
causing a movement amount of a display position of the guide information between before and after changing of the display position to be equal to or more than a predetermined first threshold value.
12.
The image processing method according to supplementary note 11, further including,
by the computer,
causing a movement amount of a display position of the guide information between before and after changing of the display position to be equal to or less than a second threshold value larger than the first threshold value.
13.
The image processing method according to any one of supplementary notes 9 to 12, further including,
by the computer,
controlling a display position of the guide information within a range narrower than an angle view of the image capturing apparatus.
14.
The image processing method according to any one of supplementary notes 9 to 13, further including,
by the computer,
changing a display position of the guide information along a height direction of a display area for displaying the video.
15.
The image processing method according to any one of supplementary notes 9 to 14, further including,
by the computer,
changing a display position of the guide information along a width direction of a display area for displaying the video.
16.
An image processing method executed by a computer, including:
analyzing an image in a video captured by an image capturing apparatus, and detecting a pose of a personal identification document in the image;
acquiring, as an image to be processed, an image in the video in which a pose associated to any of a plurality of reference poses preset for the personal identification document is detected; and
outputting, onto the video, guide information representing a reference pose of the personal identification document while changing a type thereof, depending on a detection result of a pose of the personal identification document.
17.
A program for causing a computer to function as:
an image analysis unit that analyzes an image in a video captured by an image capturing apparatus, and detects a pose of a personal identification document in the image;
an image acquisition unit that acquires, as an image to be processed, an image in the video in which a pose associated to any of a plurality of reference poses preset for the personal identification document is detected; and
a guide information output unit that outputs, onto the video, guide information representing a reference pose of the personal identification document while changing a type and a display position thereof, depending on a detection result of a pose of the personal identification document.
18.
The program according to supplementary note 17, wherein
the guide information output unit changes a type and a display position of the guide information, in response to detection of a pose, as a pose of the personal identification document, associated to a reference pose specified by the guide information.
19.
The program according to supplementary note 17 or 18, wherein
the guide information output unit causes a movement amount of a display position of the guide information between before and after changing of the display position to be equal to or more than a predetermined first threshold value.
20.
The program according to supplementary note 19, wherein
the guide information output unit causes a movement amount of a display position of the guide information between before and after changing of the display position to be equal to or less than a second threshold value larger than the first threshold value.
21.
The program according to any one of supplementary notes 17 to 20, wherein
the guide information output unit controls a display position of the guide information within a range narrower than an angle view of the image capturing apparatus.
22.
The program according to any one of supplementary notes 17 to 21, wherein
the guide information output unit changes a display position of the guide information along a height direction of a display area for displaying the video.
23.
The program according to any one of supplementary notes 17 to 22, wherein
the guide information output unit changes a display position of the guide information along a width direction of a display area for displaying the video.
24.
A program for causing a computer to function as:
an image analysis unit that analyzes an image in a video captured by an image capturing apparatus, and detects a pose of a personal identification document in the image;
an image acquisition unit that acquires, as an image to be processed, an image in the video in which a pose associated to any of a plurality of reference poses preset for the personal identification document is detected; and
a guide information output unit that outputs, onto the video, guide information representing a reference pose of the personal identification document while changing a type thereof, depending on a detection result of a pose of the personal identification document.

This application is based upon and claims the benefit of priority from Japanese patent application No. 2021-007923 filed on Jan. 21, 2021, the disclosure of which is incorporated herein in its entirety by reference.

### REFERENCE SIGNS LIST

1 Image processing system
10 User terminal
20 Image capturing apparatus
30 Display
40 Server
110 Image analysis unit
120 Image acquisition unit
130 Guide information output unit
1010 Bus
1020 Processor
1030 Memory
1040 Storage device
1050 Input/output interface
1060 Network interface
G1, G2, G3, G4, G5, G6 Guide information
S1, S2, S3, S4, S5, S6 Screen

What is claimed is:

1. An image processing system comprising:
at least one memory configured to store instructions; and
at least one processor configured to execute the instructions to perform operations, the operations comprising:
analyzing an image in a video captured by a camera;
detecting a pose of a personal identification document in the image;
acquiring, as an image to be processed, an image in the video in which a pose associated to any of a plurality of reference poses preset for the personal identification document is detected; and
outputting, onto the video, guide information representing a reference pose of the personal identification document while changing a type and a display position thereof, depending on a detection result of a pose of the personal identification document.

2. The image processing system according to claim 1, wherein
the operations comprise changing a type and a display position of the guide information, in response to detection of a pose, as a pose of the personal identification document, associated to a reference pose specified by the guide information.

3. The image processing system according to claim 1, wherein
the operations comprise causing a movement amount of a display position of the guide information between before and after changing of the display position to be equal to or more than a predetermined first threshold value.

4. The image processing system according to claim 3, wherein
the operations comprise causing a movement amount of a display position of the guide information between before and after changing of the display position to be equal to or less than a second threshold value larger than the first threshold value.

5. The image processing system according to claim 1, wherein
the operations comprise controlling a display position of the guide information within a range narrower than an angle view of the camera.

6. The image processing system according to claim 1, wherein
the operations comprise changing a display position of the guide information along a height direction of a display area for displaying the video.

7. The image processing system according to claim 1, wherein
the operations comprise changing a display position of the guide information along a width direction of a display area for displaying the video.

8. (canceled)

9. An image processing method executed by a computer, comprising:
analyzing an image in a video captured by a camera;
detecting a pose of a personal identification document in the image;
acquiring, as an image to be processed, an image in the video in which a pose associated to any of a plurality of reference poses preset for the personal identification document is detected; and
outputting, onto the video, guide information representing a reference pose of the personal identification document while changing a type and a display position thereof, depending on a detection result of a pose of the personal identification document.

10. The image processing method according to claim 9, further comprising,
by the computer,
changing a type and a display position of the guide information, in response to detection of a pose, as a pose of the personal identification document, associated to a reference pose specified by the guide information.

11. The image processing method according to claim 9, further comprising,
by the computer,
causing a movement amount of a display position of the guide information between before and after changing of the display position to be equal to or more than a predetermined first threshold value.

12. The image processing method according to claim 11, further comprising,
by the computer,
causing a movement amount of a display position of the guide information between before and after changing of the display position to be equal to or less than a second threshold value larger than the first threshold value.

13. The image processing method according to claim 9, further comprising,
by the computer,
controlling a display position of the guide information within a range narrower than an angle view of the camera.

14. The image processing method according to claim 9, further comprising,
by the computer,
changing a display position of the guide information along a height direction of a display area for displaying the video.

15. (canceled)

16. (canceled)

17. A non-transitory computer-readable medium storing a program for causing a computer to perform operations, the operations comprising:
analyzing an image in a video captured by a camera;
detecting a pose of a personal identification document in the image;
acquiring, as an image to be processed, an image in the video in which a pose associated to any of a plurality of reference poses preset for the personal identification document is detected; and
outputting, onto the video, guide information representing a reference pose of the personal identification document while changing a type and a display position thereof, depending on a detection result of a pose of the personal identification document.

18. The non-transitory computer-readable medium according to claim 17, wherein
the operations comprise changing a type and a display position of the guide information, in response to detection of a pose, as a pose of the personal identification document, associated to a reference pose specified by the guide information.

19. The non-transitory computer-readable medium according to claim 17, wherein
the operations comprise causing a movement amount of a display position of the guide information between before and after changing of the display position to be equal to or more than a predetermined first threshold value.

20. The non-transitory computer-readable medium according to claim 19, wherein
the operations comprise causing a movement amount of a display position of the guide information between before and after changing of the display position to be equal to or less than a second threshold value larger than the first threshold value.

21. The non-transitory computer-readable medium according to claim 17, wherein
the operations comprise controlling a display position of the guide information within a range narrower than an angle view of the camera.

22. The non-transitory computer-readable medium according to claim 17, wherein
the operations comprise changing a display position of the guide information along a height direction of a display area for displaying the video.

23. The non-transitory computer-readable medium according to claim 17, wherein
the operations comprise changing a display position of the guide information along a width direction of a display area for displaying the video.

24. (canceled)
